(19) United States
(12) Patent Application Publication
(10) Pub. No.: US 2024/0370028 A1
(43) Pub. Date: Nov. 7, 2024

(54) System for Controlling a Self-Driving Dummy Device

(71) Applicant: 4activeSystems GmbH, Traboch (AT)

(72) Inventors: Martin Fritz, Kobenz (AT); Reinhard Hafellner, Spielberg (AT)

(21) Appl. No.: 18/556,197

(22) PCT Filed: Apr. 29, 2022
(86) PCT No.: PCT/EP2022/061557

§ 371 Date: Oct. 19, 2023

(30) Foreign Application Priority Data
Apr. 30, 2021 (AT) A 60125/2021

(51) Int. Cl. G05D 1/226; G05D 1/661

(52) U.S. Cl. CPC G05D 1/226; G05D 1/661

(57) ABSTRACT

The present disclosure relates to a system for controlling a self-driving dummy device. The system includes at least one signal transmission unit for transmitting and receiving signals and at least one self-driving dummy device, wherein the dummy device includes a dummy signaling device for transmitting and receiving signals. A plurality of signal paths is providable between the signal transmission unit and the dummy signaling device in order to transmit signals. A control device is configured to select one of the signal paths for transmitting a signal based on a signal parameter indicative of the signal quality of the signal path.

### CROSS-REFERENCE TO RELATED APPLICATIONS

This application is the U.S. national phase of International Application No. PCT/EP2022/061557 filed Apr. 29, 2022, which designated the U.S. and claims priority to Austrian Patent Application No. A 60125/2021, filed Apr. 30, 2021, the entire contents of each of which are hereby incorporated herein by reference.

### TECHNICAL FIELD

The present disclosure relates to a system and a method for controlling a self-driving dummy device.

### BACKGROUND OF THE DISCLOSURE

Motor vehicles are increasingly being equipped with driver assistance systems to actively support the driver of the motor vehicle in certain traffic situations and reduce the risk of accidents. For example, modern driver assistance systems may influence the braking function or the steering of the motor vehicle.

Furthermore, autonomously driving motor vehicles are used in modern traffic areas, in which the motor vehicle steers fully automatically through the traffic of a determined traffic area without the driver actively participating in the driving behavior of the motor vehicle.

For testing motor vehicles with driver assistance systems or for testing autonomously driving motor vehicles, complex traffic scenarios with a variety of road users have to be simulated. It is no longer sufficient to simulate a collision or near-collision situation between a test vehicle and another traffic partner, such as a human dummy or another dummy vehicle. Rather, it is necessary to simulate a traffic scenario with a variety of different road users, such as people, bicycles and/or motor vehicles, which have different motion characteristics. Only with a complex test system that simulates a real complex traffic situation can driver assistance systems and autonomous driving vehicles be tested in a reliable manner.

To simulate complex traffic situations, it is necessary to ensure a secure exchange of data between the individual road users. At the same time, the test scenarios must be adapted and changed frequently, so that a test system for simulating complex traffic situations should be designed to be as simple and quick to install as possible.

### SUMMARY OF THE DISCLOSURE

There may be a need to provide a test system for simulating complex traffic situations.

This need may be by a system and a method for controlling a self-driving dummy device according to the subject matter of the independent claims.

According to a first aspect of the present disclosure, a system for controlling a self-driving dummy device is provided. The system comprises at least one signal transmission unit for transmitting and receiving signals and at least one self-driving (self-propelled) dummy device. The dummy device comprises a dummy signaling device for transmitting and receiving signals, wherein a plurality of signal paths is providable (can be provided) between the signal transmission unit and the dummy signaling device in order to transmit signals. The system further comprises a control device configured to select one of the signal paths for transmitting a signal based on a signal parameter indicative of the signal quality of the signal path.

According to a further aspect, a method of controlling a self-driving dummy device is described. The method comprises transmitting and receiving signals with at least one signal transmission unit and transmitting and receiving signals with a dummy signaling device of the dummy device, wherein a plurality of signal paths is providable between the signal transmission unit and the dummy signaling device in order to transmit signals. Further, the method comprises selecting one of the signal paths for transmitting a signal by means of a control device on the basis of a signal parameter indicative of the signal quality of the signal path.

### Overview of Embodiments

The system according to the present disclosure is intended to enable safe data exchange between different road users in a simulated and complex traffic situation. For example, the self-driving dummy device may simulate a human road user. Furthermore, the dummy device may simulate a motor vehicle, such as a car or a motorcycle. In this regard, the dummy device may have, for example, certain directions of movement and speeds of movement that are intended to simulate a complex traffic situation. The dummy device is thereby self-driving, meaning that the dummy device may be moved along a desired movement path in a freely controllable manner. In this regard, the dummy device may be remotely controlled by a control base or set a desired movement path itself, for example in the case of simulation of an autonomously driving motor vehicle. In this regard, the dummy device may, for example, comprise driver assistance systems to be tested, such as a lane steering assistant or a brake force assistant. In addition, the dummy device may, for example, have its own control device for autonomously controlling the dummy device. In this regard, the dummy device may be equipped with a required sensor system, such as radar sensors, position sensors, or distance sensors. The system may be used to control a plurality of dummy devices with different dummy setups or to network them for signal exchange.

The dummy device further comprises a dummy signaling device with which signals may be transmitted and received. Furthermore, the system comprises a signal transmission unit which may transmit and receive corresponding signals, in particular to or from the dummy device.

The signals may include information about position, movement paths or other status information (for example, battery charge status), which is provided for exchange between the signal transmission unit and the dummy device. In particular, the signals are transmitted wirelessly. The network of the control system may be of a cellular network type and may operate, for example, using a 4G or 5G standard. For example, the system may have a WLAN (Wireless Local Area Network) network, with the signal transmission unit or the dummy signaling device having corresponding routers or access points (wireless access points) to the network. For example, the network may be built according to standards such as IEEE 802.11 a, b, g, n, ac or ax and transmit with corresponding frequency blocks between 2.4 GHz (gigahertz) and 5.0 GHz, 5.5 GHz or 5.7 GHz. The bandwidths may range from 20 MHz to 160 MHz. In particular, the network may be formed in the manner of a mesh WLAN network. The signal transmission units and the dummy signaling devices form WLAN components and, correspondingly, a wireless local area network which, by connecting and jointly controlling the components (base and satellites), is seen by the dummy devices located in the “mesh area” as a unified WLAN and is intended to ensure reception over as wide an area as possible while maintaining a constant transmission speed.

The signal transmission unit may be installed, for example, in a system control base from which control signals are generated and transmitted to control the complex traffic situations, or in another self-driving dummy device.

In conventional control systems of self-driving dummy devices, in particular predetermined transmission paths or signal paths are defined. For example, a dummy device may always communicate directly with a conventional control base directly or via a signal amplifier. However, the predetermined transmission path does not yet take into account any real-life boundary conditions, such as interruption of the signal path between the conventional control base and the conventional dummy device, so that there is a risk of interruption of the signal exchange.

With the system for controlling the self-driving dummy device according to the present disclosure, two or more different signal paths are provided between the signal transmission unit and the dummy signaling device. For example, a signal path may provide a direct transmission path between the dummy device and the signal transmission unit. Further, a signal path may be generated via one or a plurality of intermediate units, such as via a plurality of signal transmission units (signal amplifiers (e.g., routers, etc.)).

A control device, which is installed in the dummy device or in a central control base, for example, is configured according to the present disclosure for selecting the signal path which is qualitatively the most suitable for transmitting the signal. For this purpose, various signal parameters indicative of a signal quality or transmission quality of the signal may be used. For example, the control device may check the bandwidth or signal strength of each transmission path and select the most suitable transmission path accordingly.

The control device is, for example, a computer comprising a processor that may perform the process steps described above. In other words, the control device may measure the signal parameters, or process the measured parameter data, and select a signal path for data transmission based thereon and on the predetermined signal parameters. The method according to the present disclosure may thus represent a computer-implemented method which may be implemented at least partially in the control device and executed thereon.

With the present disclosure, the control device may thus select a signal path that has the most suitable signal parameters, e.g. transmission rate and signal strength, based on the signal quality of the individual signal paths, in order to reliably ensure signal transmission. In doing so, the control device may permanently check the values of the signal parameters and switch to another more suitable signal path accordingly if one signal path is weakened or interrupted. If, for example, there is suddenly a signal-shielding obstacle in a signal path, the system switches to another signal path that guarantees obstacle-free transmission. Thus, in a dynamic simulation event involving a large number of self-driving dummy devices, the best signal path for signal exchange between the units of the system may be permanently selected and a reliable signal exchange and corresponding data exchange may be ensured.

Furthermore, the control device is configured to categorize the type of signals or information to be transmitted. For example, it may prioritize whether a signal path must have a high transmission reliability, a high latency or a high data volume in order to transmit the desired signals. For example, if the signals to be transmitted are large image data, the control unit may select a signal path that has a high bandwidth or a high transmission rate. If the signals to be transmitted are signals that are relevant to speed or must be transmitted quickly, the control device may select a signal path that has at least a low bandwidth but a low latency or a fast data transmission rate.

According to another exemplary embodiment, the dummy device comprises the control device coupled to the dummy signaling device. For example, all dummy devices may have corresponding control devices. For example, each control device forms a router for the radio network over which the signal paths are formed. For example, the control device in the dummy device itself may select the appropriate signal path based on the signal parameters. For example, each dummy device is equipped with a control device, each of which forms part of a mesh network. A control device in a dummy device may act as a so-called mesh master and specify a signal path.

According to another exemplary embodiment, the signal transmission unit is a non-movable (stationary) unit comprising the control device. The signal transmission unit may thus form, for example, a stationary network node and, as described below, may form, for example, a central base station or another functional unit, such as a charging station.

According to another exemplary embodiment, the signal transmission unit is a central control base. From the central control base, the movement paths of the dummy devices as well as the corresponding speeds for the dummy devices may be controlled. For example, the control device may be integrated in the central control base and accordingly select suitable signal paths for transmitting signals to the desired dummy device.

According to another exemplary embodiment, the system comprises a further signal transmission unit, wherein at least one of the signal paths between the signal transmission unit and the dummy signaling device is provided via the further signal transmission unit. For example, a movement path may extend from the central control base via a plurality of transmission masts (as a further signal transmission unit) until the desired dummy device is reached.

Accordingly, according to another exemplary embodiment, the further signal transmission unit may be a non-movable unit, in particular a transmission mast.

According to another exemplary embodiment, the system comprises a plurality of further signal transmission units which are transmission masts, wherein one of the signal paths between the signal transmission unit and the dummy signaling device is provided via one or a plurality of transmission masts.

According to another exemplary embodiment, at least one of the transmission masts comprises a further control device configured to select one of the signal paths for transmitting signals on the basis of signal parameters indicative of the signal quality of the signal path. Thus, for example, a signal path may be defined not only by a dummy device itself or by a central base station, but a check of the signal parameters may be performed at each network node of the signal path and the further course of the signal path may be adapted. If, for example, the transmission masts have corresponding control devices that check the signal parameters of the control path, a modified signal path may be used to transmit the signals if certain signal parameters change, for example if an obstacle has occurred between two adjacent signal masts. This results in a dynamic adaptation of the signal paths, so that an optimal signal path is selected at any point in time.

According to another exemplary embodiment, the transmission masts enclose a test area in which dummy devices are allowed to be moved, wherein the control device is configured to detect an exit of the dummy device from the test area. In the test area, the desired traffic simulation is performed. In other words, the plurality of dummy devices may move in the test area to simulate a complex traffic situation accordingly. For example, the test towers are configured to determine the position of a dummy device based on the received signal from the dummy device. The test area may be bounded by a so-called virtual fence. The area inside the virtual fence is available for testing, while the area outside the virtual fence is an exclusion zone where dummy devices are stopped if they step over the virtual fence. Thus, an exit of a dummy device from the test area may be detected and based on this, for example, a position alarm may be triggered.

According to another exemplary embodiment, the further signal transmission unit is a movable device, in particular a dummy signaling device of a further movable dummy device.

Thus, for example, an extensive test area may be formed without or with a small number of signal amplifiers or transmission masts in that each dummy device itself forms its own signal transmission unit. By means of the signal transmission unit, signals may be amplified accordingly before being transmitted further. Furthermore, the signal parameters of the signal path may be used to determine whether retransmission of the signals is possible and whether the signals arrive safely and completely at the next network node accordingly. In the exemplary embodiment, a plurality of movable dummy devices may thus form movable network nodes that are coupled to each other for signal transmission and may accordingly form a signal path.

According to another exemplary embodiment, the signal transmission unit is a charging station for charging a battery of the self-driving dummy device. The dummy device includes a battery. The control device is configured to check the charge state of the battery. Further, the control device is configured to control the dummy device such that the dummy device is movable to the charging station for charging the battery. The signals regarding the state of charge of the battery may be processed, for example, by a control device in the dummy device itself or by a control device at a central base station. If the state of charge of a battery of a dummy device drops below a certain threshold value, the control device may create a movement path to the charging station. At the charging station, the dummy device may be charged again.

As described below, the self-driving dummy device has a movable platform with a base body on which a dummy assembly (dummy body) may be detachably fixed on its upper side of the base body (in particular on a mounting area).

According to another exemplary embodiment, the base body has at least two electrical or inductive contact surfaces that are freely accessible from outside the platform or that may be inductively coupled from outside the platform. The contact surfaces are connected in a current-conducting or inductive manner, for example, by means of rechargeable battery cells of the platform, wherein the two electrical or inductive contact surfaces are designed in particular in such a way that sliding contacts may be provided on the one hand with contact points of the stationary charging station. For example, the platform may move into the charging station and, at a certain charging position, establish electrical contact between the sliding contacts of the platform and the sliding contact in the charging station. Furthermore, electrical contact areas may also be formed that are arranged below the surface or close to the bottom surface of the platform and are not freely accessible from the outside. For example, the platform may move to a charging position of an inductive charging station. Thus, inductive charging may be used to charge the battery cells of the platform.

The platform may be formed to be extremely flat. According to an exemplary embodiment, the base body has a mounting area and an installation area, wherein a mounting device for mounting the dummy is formed on the mounting surface of the mounting area and functional elements (such as the control device, the signal transmission unit, the radar sensor, the position sensor or a drive unit) are installable in the installation area. The base body is so thin that a collision vehicle can drive over it without damage. Furthermore, the base body is so thin that the platform may be inserted into an extremely flat charging station, which has a corresponding flat opening (slot), for charging. Due to the flat design of the charging stations, they remain almost invisible to sensors of a vehicle under test and thus do not cause any faulty measurements. Due to the flat opening of the charging station, a charging area of the charging station is also protected from contamination.

According to an exemplary embodiment, the platform has a mounting thickness in the mounting area and an installation thickness in the installation area. The mounting thickness is less than 40 mm, in particular less than 35 mm, less than 30 mm, less than 25 mm, less than 20 mm, less than 15 mm, less than 10 mm, The installation thickness is, for example, less than 55 mm, in particular less than 50 mm, less than 45 mm, less than 40 mm, less than 35 mm, less than 30 mm, less than 25 mm, less than 20 mm, less than 15 mm, less than 10 mm. The maximum thickness of the platform between a bottom support of the roller element on the floor and the surface, in particular of the installation area, is less than 55 mm, in particular less than 50 mm, 45 mm, 40 mm or 35 mm.

The platform may thus have a homogeneous stepless surface or have a stepped surface. For example, the base body may be step-shaped, wherein in particular an installation thickness between the base surface and the surface in the installation area, in particular 30 mm, 25 mm, 20 mm, 15 mm, 10 mm, or 5 mm, is smaller than a mounting thickness between the base surface and the surface in the mounting area.

According to another exemplary embodiment, the system includes a plurality of signal transmission units configured as respective charging stations for charging a battery of the self-driving dummy device. The control device is configured to control the dummy device such that the dummy device is movable to an available charging station of the plurality of charging stations in order to charge the battery. For example, each charging station may send a corresponding signal to the control device and the dummy device, respectively, indicating the occupancy state of the charging station. For example, if a dummy device is determined to require charging, the next step may be to determine whether a charging station is occupied or vacant. The control device then determines a path of movement of the dummy device to the free charging station so that charging of the dummy device battery is possible.

Furthermore, the control device may activate another fully loaded dummy device as a substitute for the dummy device to be loaded and integrate it as a substitute for the dummy device to be loaded in the traffic situation to be simulated. Thus, despite the need to load a dummy device, the traffic situation to be simulated does not have to be interrupted, but the simulation may be continued with the dummy device that is replacing it.

The dummy devices use electrical energy storage in the form of e.g. lithium titanate batteries. Some of the characteristics of the lithium titanate batteries are a short charging time (5 minutes to fully charge) and a high number of discharge/charge cycles (at least 100,000 times). These characteristics are suitable for use in the test area, as there are always a few minutes between test scenarios to organize the next scenario or to make some preparations for the dummy devices. During this time, the dummy devices may be charged by at least one charging unit in the test area. This characteristic of the system for testing collision or near-collision situations is particularly useful, as the functionality of the whole system is improved when the time needed to maintain the system is reduced to a minimum.

According to another exemplary embodiment, the signal parameter is selected from the group consisting of a signal strength, a data size of the data/signals to be transmitted, a bandwidth of a transmission time between the signal transmission unit and the dummy device, a location of the signal transmission unit, and a location of the dummy device.

According to another exemplary embodiment, the self-driving dummy device comprises a movable platform on which a dummy assembly is detachably fixable. The dummy assembly is in particular selected from the group consisting of human dummies, car dummies, bicycle dummies, truck dummies, animal dummies, and motorcycle dummies. The dummy assembly may also represent the traffic control element or marking device or spraying device described below.

The movable platform has, for example, corresponding rollers or wheels and the corresponding drive devices. Further functional elements, such as the dummy signaling device or the control device, may also be integrated into the platform. The dummy assembly replicates the desired dummy body in terms of its shape. For example, the dummy assembly may take the shape of a human, a bicycle, or a car. In particular, the dummy assembly is attached to the platform in a replaceable or detachable manner so that the dummy assembly may detach from the platform in the event of a collision or replacement.

According to another exemplary embodiment, the system comprises an assembly station configured to attach or remove (detach) a dummy assembly to or from a movable platform. The control unit is configured to control the dummy device such that the dummy device is movable to the assembly station for attaching or removing the dummy assembly to or from the movable platform.

With the described embodiment, a dummy platform may be flexibly equipped with different types of dummy assemblies. For example, in a first simulation step, a platform may have a human dummy assembly. During the simulation, the platform may be steered to the assembly station, for example, in which the human dummy assembly is removed and another dummy assembly, such as a dummy car, may be placed on the platform. The platform with the dummy car may then be used again to simulate the traffic situation and controlled accordingly along desired motion paths. Thus, a different traffic situation may be generated quickly, automatically and flexibly with a variety of platforms as dummy devices.

According to another exemplary embodiment, the dummy device comprises an autonomous driving system with at least one sensor unit, wherein the autonomous driving system is configured to control the movement of the dummy device based on sensor data measurable with the sensor unit. The control device is configured to provide data indicative of a movement of the dummy device via the selected signal path.

The autonomous driving system of the dummy device may thus flexibly change and adapt the movement paths in the traffic simulation. For example, it may stop automatically at a traffic light if it generates a red light. Furthermore, the dummy device may stop at a crosswalk, for example, if another dummy device simulating a human dummy crosses the path of the dummy device with the autonomous driving system. The corresponding data or signals may be exchanged between the two dummy devices via the corresponding dummy signaling devices or transmitted to a central base station along a safe selected signal path.

According to another exemplary embodiment, the sensor unit is selected from the group consisting of a radar sensor, a position sensor, a slope sensor, a speed sensor, and an acceleration sensor.

The present disclosure describes a system for controlling self-driving dummy devices. The system includes dummy devices with movable platforms designed to support test objects or dummy assemblies during collision or near-collision testing. The dummy assembly is an object whose physical properties for sensor detection (visible and invisible light range and static and moving radar properties; e.g., micro-Doppler effect) match the properties of the real test object (human, vehicle, etc.). For example, the real test object is a typical road user of a complex traffic situation. For example, a test object may represent a person, a person on a bicycle or a scooter, an animal such as a dog, a boar or a deer, a vehicle such as a car, a van, a truck, etc.

The system is deployed on the test area. The test area has, for example, a flat surface with corresponding roads and sidewalks. The test objects are supported by platforms, which are driven, for example, by at least one driven rolling (movable) element. Furthermore, the platforms also have a corresponding steering system. The dummy devices may be controlled from a central controlling center, where the entire planning of the traffic simulation is performed. The (control) signals are sent to the platforms in real time via the signal paths. The platforms may include a radio transceiver as a dummy signaling device for communication with the control center, with network nodes (mesh nodes), and with other platforms. The dummy devices may further include a GPS module with at least one antenna to track a correct course or path of movement. For example, when installing the system, a second GPS antenna may be used (for example, DGPS) to track heading parameters of the motion paths.

According to an exemplary embodiment, the test area has at least one traffic control element, in particular a traffic light device, a traffic sign prescribing traffic rules, a road marking, and/or a traffic obstacle. The traffic control element has a traffic regulating parameter, in particular route information and/or speed information, for the dummy device. The control device (which is present, for example, as a central controlling center) is coupled to the traffic control element in such a way that the control device controls the dummy device based on the traffic-regulating parameters.

The route information may include, for example, a no-parking zone, a permission to turn or a prohibition to turn, a no-parking zone, an exclusion zone (for example, due to a defective vehicle), or a crosswalk, from which corresponding control information for the dummy device may be generated. For example, in the case of a crosswalk, the dummy device may come to a stop for a determined period of time before continuing. Furthermore, in a no-parking zone, for example, the dummy device may be prevented from parking. Accordingly, the dummy device may be controlled like a real road user within the test area. As described above, the control device may be a central control unit, such as a central controlling center, which controls all road users in the test area (i.e., all other dummy devices and, for example, the movable traffic devices, marking devices, and service devices described below). In addition, corresponding speed information is provided as a traffic control parameter. The speed information has, for example, a predetermined travel speed as well as determined stop instructions when, for example, a dummy device wants to pass a traffic light switched to “red”.

With the traffic control element and the corresponding coupling to the control unit, a real and highly complex test area for simulating a complex traffic situation may thus be provided. The one or the plurality of dummy devices may be controlled according to the traffic control elements in a predetermined manner, thus allowing in particular to simulate moving persons as well as moving objects, such as vehicles or motorcycles, in a real traffic flow. Accordingly, for example, a real and highly complex traffic situation is simulated for a test of a vehicle with autonomous driving characteristics and corresponding driver assistance systems.

According to another exemplary embodiment, the system comprises a movable traffic device, in particular a movable platform, on which the traffic control element is arranged. The control device is coupled to the traffic control element such that the control device controls the traffic control element, in particular the position and/or the traffic regulating parameter.

The movable traffic device has, in particular, a movable platform on which the traffic control element may be mounted, in particular in a detachable and replaceable manner. The movable traffic device may, for example, represent a dummy device described above, wherein instead of a dummy, the traffic control element is adjusted as a dummy assembly on the platform. The movable traffic device may further comprise a mechanical and/or magnetic coupling device to which the traffic control element at the traffic device may be releasably coupled. Thus, a test area or traffic control in the test area may be flexibly changed and adjusted. For example, the number of traffic light devices and also the locations of the traffic light devices as traffic control elements may be changed between different test cycles, so that a changed test setup for a test area may be flexibly adjusted. In addition, the control unit may control the traffic control element accordingly, for example, by changing the traffic light phases or electronic traffic signs to change the displayed traffic signs.

According to another exemplary embodiment, the system comprises a movable marking device, in particular a movable platform, which has a spraying device for applying road markings. The control device is coupled to the marking device such that the control device controls the marking device based on traffic data (i.e., road routings, traffic light arrangements, traffic rules/signs, parking zones, etc.) of the test area to be defined. In particular, the movable marking device comprises a movable platform on which the spraying device may be mounted, in particular in a detachable and replaceable manner. The movable marking device may, for example, represent a dummy device as described above as a dummy assembly, wherein instead of a dummy a spraying device as a dummy assembly is adjusted on the platform. The spraying device has, for example, a corresponding colored substance which may apply or spray a corresponding road marking on a surface of the ground. The paint may be applied temporarily, i.e., a paint may be selected which decomposes after a predetermined time to display the road marking on the ground only for a limited time.

The movable marking device described above may thus be used to define an adaptable and flexible test area in which, for example, road routings, intersections and other traffic zones, such as crosswalks or parking zones, may be flexibly displayed or changed. Accordingly, for testing a desired autonomous vehicle, this may be carried out with quickly changeable test setups of the test area.

According to another exemplary embodiment, the system comprises a movable service device, in particular a movable platform, which comprises a coupling device for coupling with the dummy device. The control device is coupled to the service device such that the service device is controllable for coupling and conveying the dummy device. The service device thus provides, for example, a towing service, whereby a defective element that is not movable, such as the movable dummy device, may be coupled to the service device and moved accordingly to a desired position in the test area or outside the test area. The coupling device may, for example, be mechanical by means of a gripping unit or magnetic for providing a magnetic coupling. In particular, when a collision has been initiated between a dummy device and the vehicle under test, the service device may move the corresponding defective parts or the collided dummy device to a designated and protected area inside or outside the test area. In the meantime, an intact dummy device may replace the failed defective dummy device.

The control unit is thus configured in such a way that, on the one hand, the motion sequences of all dummy devices and, correspondingly, all road users (pedestrians, cyclists, scooter drivers, automobiles) may be controlled with predefined motion sequences. For example, the control unit may position all road users at their assigned start position. When the vehicle under test starts the test, all road users are activated by means of the control unit and predefined motion sequences are initiated so that a real and vital traffic scenario may be simulated in the test area.

For example, the signal transmission unit or dummy signaling devices are radio transceiver modules adapted to communicate with any other signal transmission unit(s) in the test area via various signal paths, including the central control base or a network node. In this way, information is transmitted not only between the base station and one of the platforms, but also between platforms and network nodes. The selection of the appropriate signal path is based on predefined signal parameters. For example, communication functions according to the principle of least latency as a signal parameter, i.e., the information is transmitted via the signal path with the shortest path in terms of time.

For example, the test area could be two kilometers long. The central base station may be at one end, while a dummy device could be in the middle towards the other end. At the end point, another dummy device waits for the command. Information or signals may reach the dummy devices at the other end via the dummy device in the middle or via multiple network nodes (for example, at signal towers) positioned along the test area, since the dummy device at the endpoint may not be accessible to the base station. Another example may include a barrier blocking a signal path or radio waves in the test area. A dummy device behind the barrier may then be indirectly available by defining a signal path via, for example, at least one other dummy device between a network node.

The system further includes a GPS base system (particularly of the DGPS type) connected to network nodes, which serves as an additional input for calculating position errors. Each dummy device may be manually operated directly by a human operator using the remote control, thereby overriding the control signals sent by the base station.

It should be noted that the embodiments described herein represent only a limited selection of possible embodiments of the present disclosure. Thus, it is possible to combine the features of individual embodiments in a suitable manner, so that for the person skilled in the art a plurality of different embodiments is to be regarded as obviously disclosed with the embodiments made explicit herein. In particular, some embodiments of the present disclosure are described with device claims and other embodiments of the present disclosure are described with method claims. However, it will immediately become clear to the person skilled in the art upon reading this application that, unless explicitly stated otherwise, in addition to a combination of features belonging to one type of subject matter of the present disclosure, any combination of features belonging to different types of subject matter of the present disclosure is also possible.

### BRIEF DESCRIPTION OF THE DRAWING

In the following, for further explanation and better understanding of the present disclosure, embodiments are described in more detail with reference to the accompanying drawing.

FIG. 1 shows a schematic representation of a test area with several movable dummy devices according to an exemplary embodiment of the present disclosure.

### DETAILED DESCRIPTION OF EXEMPLARY EMBODIMENTS

Identical or similar components in the FIGURE are marked with the same reference numerals. The illustrations in the FIGURE are schematic.

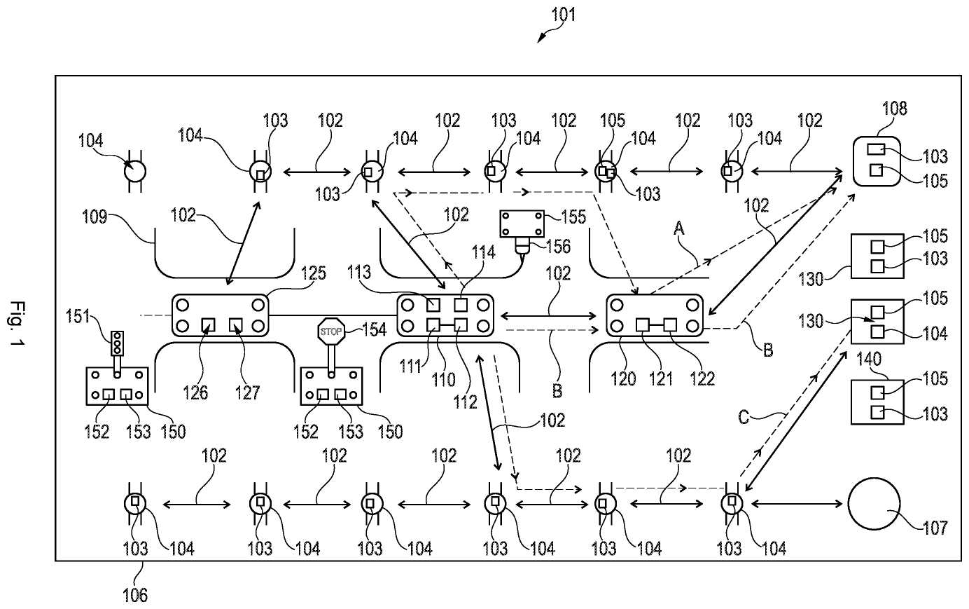

FIG. 1 shows a schematic representation of a test area 106 with several movable dummy devices 110, 120, 125 according to an exemplary embodiment of the present disclosure. A system 101 according to the present disclosure for controlling a self-driving dummy device 110 comprises at least one signal transmission unit 103 for transmitting and receiving signals and at least one self-driving dummy device 110, wherein the dummy device 110 comprises a dummy signaling device 111 for transmitting and receiving signals. A plurality of signal paths A, B may be provided between the signal transmission unit 103 and the dummy signaling device 111 in order to transmit signals. A control device 105, 112 is configured to select one of the signal paths A, B for transmitting a signal based on a signal parameter indicative of the signal quality of the signal path A, B.

The dummy devices 110, 120, 125 may have certain directions of movement and speeds of movement that are intended to simulate a complex traffic situation. The dummy device 110, 120, 125 is thereby self-driving, i.e. that the dummy device 110, 120, 125 may be freely controllably moved along a desired movement path. In this case, the dummy device 110, 120, 125 may be remotely controlled by a control base 108 or may itself set a desired movement path A, B, C, for example in the case of simulation of an autonomously driving motor vehicle as a dummy device 110, 120, 125. In this case, the dummy device 110, 120, 125 may, for example, have driver assistance systems to be tested, such as a lane steering assistant or a brake force assistant. In addition, the dummy device 110, 120, 125 may have, for example, its own control device for autonomously controlling the dummy device 110, 120, 125. In this respect, the dummy device 110, 120, 125 may be equipped with a required sensor system, such as radar sensors 113, position sensors 114 or distance sensors.

The dummy devices 110, 120, 125 each have dummy signaling devices 111, 121, 126 with which signals may be transmitted and received. Furthermore, the system 101 comprises a signal transmission unit 103 which may transmit and receive corresponding signals, in particular to or from the dummy device 110, 120, 125.

The signals may include position information, motion path information, or other state information (for example, battery charge state) provided for exchange between the signal transmission unit 103 and the dummy device 110, 120, 125.

As shown in FIG. 1, the signal transmission unit 103 may be installed, for example, in a central control base 108 from which control signals for controlling the complex traffic situations are generated and transmitted, or in another self-driving dummy device 120, 125.

A signal transmission 102 may be provided in the system 101 according to the present disclosure between a plurality of system components so that they act as network nodes. With the system 101 according to the present disclosure for controlling the self-driving dummy device 110, two or more different signal paths A, B, C are provided between one of the signal transmission units 103 and the dummy signaling device 111, 121, 126. For example, a signal path B may provide a direct transmission path between the dummy device 120 and the signal transmission unit 103, e.g., of the control base 108. Further, a signal path A may be generated via one or a plurality of intermediate units 104, such as via a plurality of transmission masts 104 as signal amplifiers (e.g., routers, etc.).

For example, a control device 112, 122, 127 may be installed in the corresponding dummy device 110, 120, 125 and/or a control device 105 may be installed in the central control base. According to the present disclosure, the control devices 105, 112, 122, 127 are configured for selecting the signal path A, B, C which qualitatively has the best suitability for transmitting the signal. For this purpose, various signal parameters indicative of a signal quality or transmission quality of the signal may be used. For example, the control device 105, 112, 122, 127 may check the bandwidth or the signal strength of each transmission path A, B, C and select the most suitable transmission path A, B, C accordingly. The control devices 105, 112, 122, 127 determine or measure the signal parameters, or process the measured parameter data, and select a suitable signal path A, B, C for data transmission based thereon and on the predetermined signal parameters.

For example, all dummy devices 110, 120, 125 may include corresponding control devices 112, 122, 127. For example, the control device 112, 122, 127 in the dummy device itself may select the appropriate signal path A, B, C based on the signal parameters. For example, each dummy device 110, 120, 125 is equipped with a control device 112, 122, 127, each of which forms part of a mesh network. A control device 112, 122, 127 in a dummy device 110, 120, 125 may act as a so-called mesh master and specify a signal path.

The signal transmission unit 103 may form a non-movable (stationary) unit, such as the central base station 108 or a transmission mast 104 comprising the control device 105. The signal transmission unit 103 may thus form a stationary network node, for example.

From the central control base 108, the movement paths A, B of the dummy devices 110, 120, 125 as well as the corresponding speeds for the dummy devices 110, 120, 125 may be controlled. For example, the control device 105 may be integrated into the central control base 108 and select appropriate signal paths A, B accordingly for transmitting signals to the desired dummy device 110, 120, 125.

A signal path A, B, C may be provided between the signal transmission unit 103 and the dummy signaling device 111, 121, 126 via a plurality of further signal transmission units 103. For example, a motion path A, B may extend from the central control base 108 via a plurality of transmission masts 104 (as a further signal transmission unit 103) until the desired dummy device 110, 120, 125 is reached.

At least one of the transmission masts 104 may further comprise another control device 105 configured to select one of the signal transmissions 102 or signal paths A, B, C for transmitting signals in the basis of signal parameters indicative of the signal quality of the signal path A, B, C. Thus, for example, not only may a signal path A, B, C be specified by a dummy device 110, 120, 125 itself or by a central base station 108, but the signal parameters may be checked at each network node of the signal path A, B, C and the further course of the signal path A, B, C may be adjusted. For example, if the transmission masts 104 have corresponding control devices 105 that check the signal parameters of the control path A, B, C, then if certain signal parameters are changed, for example if an obstacle has occurred between two adjacent signal masts 104, a changed signal path A, B, C may be used to transmit the signals. Thus, a dynamic adjustment of the signal paths A, B, C occurs so that an optimal signal path A, B, C is selected at any given time.

Each network node (node) or its control device 105 may simultaneously establish several connections (so to speak path sections of the signal paths A, B, C) to different neighbors. This redundancy initially reduces the probability of failure. If a control device 105 or node fails, the entire network is not affected, only these individual points. Furthermore, the signal paths A, B, C may be selected based on latency (=latency as signal parameter). The shortest path (in time) from a start point to a destination point of the signal paths A, B, C is calculated. Each control device 105, or node knows the cost (latency) to send data to its direct neighbors. Decisive for a data transmission from the start point to the destination point of the signal paths A, B, C are the total costs (e.g. transmission time, data rate) of the complete signal paths A, B, C. Therefore, it is possible that a node does not use its direct neighbor with the lowest costs (lowest latency) for transmission, but a direct node that has higher costs (higher latencies), but the signal path A, B, C in its entirety is cheaper.

The transmission masts 104 delimit the test area 106 in which dummy devices 110, 120, 125 are allowed to be moved, wherein the control device 105, 112, 122, 127 is configured for detecting an exit of the dummy device 110, 120, 125 from the test area 106. In the test area 106, the desired traffic simulation is performed. In other words, the plurality of dummy devices 110, 120, 125 may move in the test area 106 to simulate a complex traffic situation accordingly. For example, the test masts 104 are configured to determine a position of a dummy device 110, 120, 125 based on the received signal from the dummy device 110, 120, 125.

Furthermore, the dummy devices 110, 120, 125 with their signal transmission units 111, 121, 126 may enable an extensive test area 106 without or with a small number of signal amplifiers or transmission masts 104, since each dummy device 110, 120, 125 generates its own signal amplification. By means of the signal transmission units 111, 121, 126, signals may be amplified accordingly before retransmission.

The test area 106 further comprises at least one traffic control element, in particular a traffic light device 151, a traffic sign 154 prescribing traffic rules, a road marking 109, and/or a traffic obstacle. The traffic control element has a traffic regulating parameter, in particular route information and/or speed information, for the dummy device 110, 120, 125. The control device 105 (which is present, for example, as a central controlling center or control base 108 or is present as a decentralized control device 112 on a dummy device 110) is coupled to the traffic control element such that the control device 105 controls the dummy devices 110, 120, 125 based on the traffic regulating parameters.

From the route information, the control device 105 generates corresponding control information for the devices 110, 120, 125. For example, at a crosswalk, the dummy devices 110, 120, 125 may come to a stop for a determined period of time before proceeding.

The system 101 further comprises a movable traffic device 150, in particular a movable platform on which the traffic control element is arranged. The control device 105 is coupled to the traffic control element such that the control device 105 controls the traffic control element, in particular the position and/or the traffic regulating parameter. In particular, the movable traffic device 150 comprises a movable platform to which the traffic control element is attached, in particular in a detachable and replaceable manner. The movable traffic device 150 may represent, for example, a dummy device 110, 120, 125 described above, wherein instead of a dummy, the traffic control element is adjusted on the platform. The movable traffic device 150 accordingly comprises a further dummy signaling device 152 and, for example, a further local control device 153, whereby corresponding control signals may be transmitted with respect to the positioning of the traffic device 150 and with respect to the status data of the traffic control elements.

Thus, a test area 106 or the traffic routing in the test area 106 may be flexibly changed and adjusted. For example, the number of traffic light devices 151 and also the locations of the traffic light devices 151 may be changed between different test cycles so that a changed test setup for a test area 106 may be flexibly adjusted.

The system 101 further comprises a movable marking device 155, in particular a movable platform, comprising a spraying device 156 for applying road markings 109. The control device 105 is coupled to the marking device 155 such that the control device 105 controls the marking device 155 based on traffic data of the test area 106 to be defined. In particular, the movable marking device comprises a movable platform on which the spraying device 156 is mounted, in particular in a detachable and replaceable manner. The spraying device 156 has a corresponding colored substance that may apply or spray a corresponding road marking 109 on a surface of the ground.

Thus, for example, road routings, intersections and other traffic zones, such as crosswalks or parking zones, may be flexibly displayed on the ground in the test area 106.

Further, the system 101 comprises a charging station 130 for charging a battery of the self-driving dummy device 110, 120, 125. The dummy device 110, 120, 125 comprises a battery. The control device 105, 112, 122, 127 is configured to check the charge state of the battery. Further, the control device 105, 112, 122, 127 is configured to control the dummy device 110, 120, 125 such that the dummy device 110, 120, 125 is movable to the charging station 130 for charging the battery. The signals relating to the state of charge of the battery may be processed, for example, by a control device in the dummy device 112, 122, 127 itself or by a control device 105 at a central base station 106.

For example, the system includes a plurality of charging stations 130 for charging a battery of the self-driving dummy device 110, 120, 125. The control device 105, 112, 122, 127 is configured to control the dummy device 110, 120, 125 such that the dummy device 110, 120, 125 is movable to an available charging station 130 of the plurality of charging stations 130 in order to charge the battery. For example, each charging station 130 may send a corresponding signal to the control device 105, 112, 122, 127 indicating the occupancy status of the charging station. For example, if a dummy device is determined to be in need of charging, the next step may be to determine whether a charging station 130 is occupied or vacant. The control device 105, 112, 122, 127 then determines a path of movement of the dummy device 110, 120, 125 to the free charging station 130 so that charging of the battery of the dummy device 110, 120, 125 is possible.

Further, the system 101 comprises an assembly station 140 configured to attach or remove a dummy device to or from a movable platform of the dummy device 110, 120, 125. The control unit is configured to control the dummy device 110, 120, 125 such that the dummy device 110, 120, 125 is movable to the assembly station 140 for attaching or removing the dummy assembly to or from the movable platform. The dummy assembly is, for example, a human dummy, a car dummy, a bicycle dummy, a truck dummy, an animal dummy, a motorcycle dummy, a traffic control element, or a spraying device 156.

The dummy platform may thus be flexibly equipped with different types of dummy assemblies. For example, in a first simulation step, a platform may have a human dummy assembly. During the simulation, the platform may be steered to, for example, the assembly station 140, where the human dummy assembly is removed and another dummy assembly, such as a dummy car, may be placed on the platform. The platform with the dummy car may then be used again to simulate the traffic situation and steered along desired movement paths accordingly.

The system 101 further comprises a GPS base system 107 (in particular of the DGPS type) connected to network nodes and serving as an additional input for calculating position errors. Each dummy device may include, for example, a GPS position sensor 114. At the same time, a connection may be established to the GPS base system 107 in order to correct GPS data measured by the position sensor 114.

Supplementally, it should be noted that “comprising” does not exclude other elements or steps, and “a” or “an” does not exclude a plurality. Further, it should be noted that features or steps that have been described with reference to one of the above embodiments may also be used in combination with other features or steps of other embodiments described above. Reference signs in the claims are not to be regarded as a limitation.

List of reference signs:

101 system
102 signal transmission
103 signal transmission unit
104 transmission mast
105 control device
106 test area
107 GPS base
108 central control base
109 road marking
110 dummy device
111 dummy signaling device
112 control device
113 radar sensor
114 position sensor
120 further dummy device
121 further dummy signaling device
122 further control device
125 further dummy device
126 further dummy signaling device
127 further control device
130 charging station
140 assembly station
150 movable traffic device
151 traffic light device
152 further dummy signaling device
153 further control device
154 traffic sign
155 movable marking device
156 spraying device
A, B, C signal paths

1. A system for controlling a self-driving dummy device, the system comprising:
at least one signal transmission unit for transmitting and receiving signals,
at least one self-driving dummy device, wherein the dummy device comprises a dummy signaling device for transmitting and receiving signals, wherein a plurality of signal paths is providable between the signal transmission unit and the dummy signaling device in order to transmit signals,
a control device configured to select one of the signal paths for transmitting a signal based on a signal parameter indicative of the signal quality of the signal path.

2. The system according to claim 1, wherein the dummy device comprises the control device coupled to the dummy signaling device; and/or
wherein the signal transmission unit is a non-movable unit comprising the control device.

3.-4. (canceled)

5. The system according to claim 1, further comprising:
a further signal transmission unit, wherein at least one of the signal paths between the signal transmission unit and the dummy signaling device is provided via the further signal transmission unit.

6. The system according to claim 5, wherein the further signal transmission unit is a non-movable unit.

7. The system according to claim 6, further comprising:
a plurality of further signal transmission units, which are transmission masts, wherein one of the signal paths between the signal transmission unit and the dummy signaling device is provided via one or a plurality of transmission masts.

8. The system according to claim 7, wherein at least one of the transmission masts comprises a further control device configured to select one of the signal paths for transmitting signals based on signal parameters indicative of the signal quality of the signal path.

9. The system according to claim 7, wherein the transmission mast encloses a test area in which dummy devices are allowed to be moved, wherein the control device is configured to detect an exit of the dummy device from the test area.

10. The system according to claim 9,
wherein the test area comprises at least one traffic control element,
wherein the traffic control element comprises a traffic regulating parameter for the dummy device,
wherein the control device is coupled to the traffic control element such that the control device controls the dummy device based on the traffic regulating parameters.

11. The system according to claim 10, further comprising:
a movable traffic device, on which the traffic control element is arranged, wherein the control device is coupled to the traffic control element such that the control device controls the traffic control element; and/or
a movable marking device, which has a spraying device for applying road markings, wherein the control device is coupled to the marking device such that the control device controls the marking device based on traffic data of the test area to be defined.

12. (canceled)

13. The system according to claim 1, further comprising:
a movable service device, which has a coupling device for coupling with the dummy device, wherein the control device is coupled to the service device such that the service device is controllable for coupling and conveying the dummy device.

14. (canceled)

15. The system according to claim 1, wherein the signal transmission unit is a charging station for charging a battery of the self-driving dummy device,
wherein the dummy device comprises a battery,
wherein the control device is configured to check the charge state of the battery,
wherein the control device is configured to control the dummy device such that the dummy device is movable to the charging station for charging the battery.

16. The system according to claim 15,
a plurality of signal transmission units formed as respective charging stations for charging a battery of the self-driving dummy device,
wherein the control device is configured to control the dummy device such that the dummy device is movable to an available charging station of the plurality of charging stations to charge the battery.

17. The system according to claim 1, wherein the signal parameter is selected from the group consisting of a signal strength, a data size of the data to be transmitted, a bandwidth of a transmission time between the signal transmission unit and the dummy device, a location of the signal transmission unit, and a location of the dummy device.

18. The system according to claim 1, wherein the self-driving dummy device comprises a movable platform on which a dummy assembly is releasably fixable.

19. The system according to claim 18,
wherein the base body of the platform has a mounting area and an installation area,
wherein a mounting device for mounting the dummy assembly is formed on the mounting surface of the mounting area,
wherein functional elements are installable in the installation area,
wherein base body is so thin that a collision vehicle can drive over the base body without damage.

20. The system according to claim 19,
wherein a mounting thickness of the mounting area is less than 40 mm and/or,
wherein an installation thickness of the installation area is less than 55 mm and/or,
wherein the maximum thickness of the platform between a bottom support of the roller element on the floor and the surface is less than 55 mm.

21. The system according to claim 18, further comprising:
an assembly station configured to attach or remove a dummy assembly to or from a movable platform,
wherein the control unit is configured to control the dummy device such that the dummy device is movable to the assembly station for attaching or removing the dummy assembly to or from the movable platform.

22. The system according to claim 1,
wherein the dummy device comprises an autonomous driving system with at least one sensor unit,
wherein the autonomous driving system is configured to control the movement of the dummy device based on sensor data measurable with the sensor unit,
wherein the control device is configured to provide data indicative of movement of the dummy device via the selected signal path.

23. The system according to claim 22,
wherein the sensor unit is selected from the group consisting of a radar sensor, a position sensor, a slope sensor, a speed sensor, and an acceleration sensor.

24. A method of controlling a self-driving dummy device, the method comprising:
transmitting and receiving signals with at least one signal transmission unit,
transmitting and receiving signals with a dummy signaling device of the dummy device,
wherein a plurality of signal paths is providable between the signal transmission unit and the dummy signaling device in order to transmit signals, and
selecting one of the signal paths for transmitting a signal by operation of a control device based on a signal parameter indicative of the signal quality of the signal path.
